(19) United States
(12) Patent Application Publication
(10) Pub. No.: US 2022/0197113 A1
(43) Pub. Date: Jun. 23, 2022

(54) PHOTOGRAPHING DEVICE AND FOCUSING METHOD THEREFOR, AND COMPUTER-READABLE STORAGE MEDIUM THEREFOR

(71) Applicant: Shenzhen Reolink Technology Co., Ltd., Shenzhen (CN)

(72) Inventors: Deqiu MEI, Shenzhen (CN); Xuezheng YANG, Shenzhen (CN)

(21) Appl. No.: 17/352,369

(22) Filed: Jun. 21, 2021

(30) Foreign Application Priority Data
Dec. 17, 2020 (CN) 202011499113.2

(51) Int. Cl. G03B 13/36; G03B 3/10; G02B 7/09

(52) U.S. Cl. CPC G03B 13/36; G02B 7/09; G03B 3/10

(57) ABSTRACT

The present disclosure provides a photographing device and a focusing method therefor, and a computer-readable storage medium therefor. The focusing method includes, if a first rotation direction is inconsistent with a historical rotation direction: determining a first number of driving steps based on a sum of a preset number of driving steps and a preset number of correction steps first, and controlling the motor to rotate for the first number of driving steps in the first rotation direction, wherein the preset number of correction steps is greater than or equal to the number of idling steps of the motor; and controlling the motor to rotate for the preset number of correction steps in a second rotation direction that is opposite to the first rotation direction. The focusing method for a photographing device of the present application has the advantage of high focus speed.

### CROSS-REFERENCE TO RELATED APPLICATION

The present application claims priority from the Chinese Invention Patent Application No. 202011499113.2 filed Dec. 17, 2020, and the disclosure of which is incorporated herein by reference in its entirety.

### FIELD OF THE INVENTION

The present invention relates to the technical field of video capturing, in particular, a photographing device and a focusing method therefor, and a computer-readable storage medium therefor.

### BACKGROUND OF THE INVENTION

With the development of photography technologies, most of the current video cameras have been able to achieve autofocus.

The autofocus of a video camera mainly relies on a processor to control the operation of a zoom motor and a focus motor in hardware to drive a zoom lens of the video camera to move to achieve focusing. The zoom motor and the focus motor drive the zoom lens to move through a gear transmission mechanism.

Due to factors such as machining accuracy, machining errors, and assembling errors, a driving gear on a motor shaft and a driven gear on the lens do not completely mesh, and there is a certain gap therebetween. It is known that the prerequisite for the driving gear to drive the driven gear to rotate is that saw teeth of the driving gear abut against saw teeth of the driven gear. However, due to the existence of the above-mentioned gap, in a zooming process, when the current rotation direction of the motor shaft changes compared to a historical rotation direction (for example, the last movement of the motor shaft is a counterclockwise rotation, and the current movement is a clockwise rotation), the driving gear needs to rotate for a certain angle first to offset the gap between the saw teeth of the driving gear and the saw teeth of the driven gear, and then the driven gear can be driven to rotate. This process of offsetting the gap is referred to as the motor idling, and the number of steps that the motor takes to offset the gap is referred to as the number of idling steps.

Due to the existence of the motor idling, an actual position of the lens does not match a logical position in the focusing process, which in turn causes the video camera to repeatedly adjust the focal length, resulting in a low focus speed.

### SUMMARY OF THE INVENTION

The embodiments of the present invention are directed to solve the technical problem of low focusing speed of a current video camera by means of providing a focusing method for a photographing device.

In order to achieve the above-mentioned purpose, the embodiments of the present invention provide a focusing method for a photographing device, including:

acquiring a preset number of driving steps and a first rotation direction of a motor shaft in a first preset driving command;

acquiring a historical rotation direction of the motor shaft;

determining whether the first rotation direction is consistent with the historical rotation direction;

if the first rotation direction is consistent with the historical rotation direction, determining a first number of driving steps to be the preset number of driving steps;

if the first rotation direction is not consistent with the historical rotation direction, performing the following steps:

determining the first number of driving steps based on a sum of the preset number of driving steps and a preset number of correction steps first, wherein the preset number of correction steps is greater than or equal to a number of idling steps of the motor; and

controlling the motor to rotate for the first number of driving steps in the first rotation direction, and controlling the motor to rotate for the preset number of correction steps in a second rotation direction to a first target position, wherein the second rotation direction is opposite to the first rotation direction.

In one embodiment, the focusing method for a photographing device further includes:

generating the first preset driving command according to an autofocus algorithm and a current focus state of the photographing device.

In one embodiment, after the motor moves to the first target position, the focusing method for a photographing device further includes:

if the first rotation direction is not consistent with the historical rotation direction, updating the historical rotation direction into the second rotation direction.

In one embodiment, the motor is one or two of a zoom motor and a focus motor.

In one embodiment, when the motor is a zoom motor, after the zoom motor moves to the first target position, the focusing method of a photographing device further includes:

acquiring a current focal length of the photographing device;

generating a second preset driving command of the focus motor of the photographing device based on a focal length-focus table; and

controlling the focus motor based on the second preset driving command to complete focusing of the photographing device.

In one embodiment, the generating a second preset driving command of the focus motor of the photographing device based on a focal length-focus table includes:

acquiring a theoretical number of driving steps corresponding to the current focal length based on the focal length-focus comparison table;

acquiring a preset adjustment interval based on the theoretical number of driving steps; and

generating the second preset driving command based on the preset adjustment interval.

In one embodiment, the acquiring a preset adjustment interval of the focus motor based on the theoretical number of driving steps includes:

respectively calculating a sum and a difference between the theoretical number of driving steps and a preset adjustment value to respectively serve as two end points of the present adjustment interval.

In one embodiment, the controlling the focus motor based on the second preset driving command to complete focusing of the photographing device includes:

controlling the focus motor to move from any end point of the preset adjustment interval to the other end point; and

controlling the focus motor to move to a second target position after the focus motor moves to the other end point, wherein the second target position corresponds to a clearest image acquisition position in the preset adjustment interval.

In order to achieve the above purpose, the embodiments of the present application further provide a photographing device including a memory and a processor. The memory stores a focus program for a photographing device that, when executed by the processor, implements the above-mentioned focusing method for a photographing device.

In order to achieve the above purpose, the embodiments of the present application further provide a computer-readable storage medium. The computer-readable storage medium stores a focus program for a photographing device that, when executed by a processor, implements the above-mentioned focusing method for a photographing device.

In the focusing method for a photographing device in the technical solutions of the present application, when it is determined that the first rotation direction in the first preset driving command is inconsistent with the historical rotation direction of the motor shaft, the motor is controlled to rotate for the first number of driving steps in the first rotation direction first and is then controlled to rotate for the number of correction steps in the second rotation direction, so that actual position data of a lens is caused to match position data used in the autofocus algorithm, thereby greatly increasing the focusing speed of the photographing device.

### BRIEF DESCRIPTION OF THE DRAWINGS

To describe the technical solutions in embodiments of this application or in the existing technology more clearly, the following briefly describes the accompanying drawings required for describing the embodiments or the existing technology. Apparently, the accompanying drawings in the following description show merely some embodiments of the present disclosure, and a person of ordinary skill in the art may derive other drawings from the accompanying drawings without creative efforts.

FIG. 1 is a modular structure diagram of one embodiment of a photographing device of the present invention;

FIG. 2 is a flowchart diagram of one embodiment of a focusing method for a photographing device of the present invention;

FIG. 3 is a schematic diagram of a position state of a lens of a photographing device in a factor training process;

FIG. 4 is a schematic diagram of a position state of a lens when an exemplary focusing method is used to perform focusing;

FIG. 5a is a schematic diagram I of a position state of a lens when a focusing method for a photographing device of the present application is used;

FIG. 5b is a schematic diagram II of a position state of a lens when a focusing method for a photographing device of the present application is used;

FIG. 6 is a flowchart diagram of another embodiment of a focusing method for a photographing device of the present invention; and

FIG. 7 is a flowchart diagram of a further embodiment of a focusing method for a photographing device of the present invention.

### DETAILED DESCRIPTION

It should be understood that the specific embodiments described herein are merely used to explain the present invention but are not intended to limit the present invention.

In order to better understand the above technical solutions, the exemplary embodiments of the present disclosure will be described in more details below with reference to the accompanying drawings. Although the accompanying drawings show the exemplary embodiments of this application, it should be understood that this application may be implemented in various manners and is not limited by the embodiments described herein. Rather, these embodiments are provided, so that this application is more thoroughly understood and the scope of this application is completely conveyed to a person skilled in the art.

It should be noted that in the claims, any reference signs placed between parentheses shall not be construed as limiting the claims. The “include” herein does not preclude the existence of parts or steps not listed in the claims. The word “a” or “an” preceding an element does not exclude the presence of a plurality of such components. The present invention can be implemented by way of hardware including several different components and an appropriately programmed computer. In the unit claims enumerating several apparatuses, several of these apparatuses can be specifically embodied by the same item of hardware. The use of “first,” “second,” and “third” does not indicate any order and can be interpreted as a name.

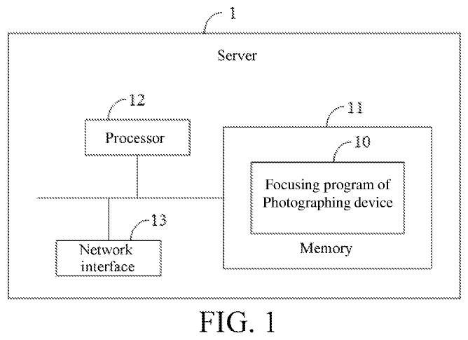

As shown in FIG. 1, FIG. 1 is a schematic structural diagram of a server 1 (also referred to as a photographing device) in a hardware operating environment related in the solutions of the embodiments of the present invention.

The server of the embodiments of the present invention is a device having a display function, such as an “Internet of things device,” a video camera, a camera, an AR/VR device with a networking function, an intelligent sound box, a self-driving automobile, a PC, a smart phone, a flat computer, an electronic book reader, and a portable computer.

As shown in FIG. 1, the server 1 includes: a memory 11, a processor 12, and a network interface 13.

The memory 11 includes at least one type of readable storage medium, and the readable storage medium includes a flash memory, a hard disk, a multimedia card, a card-type memory (for example, a secure digital (SD) or DX memory), a magnetic memory, a magnetic disk, an optical disk, and the like. The memory 11 may be an internal storage unit of the server 1 in some embodiments, such as a hard disk of the server 1. In some other embodiments, the memory 11 may also be an external storage device of the server 1, such as a plug-in hard disk, a smart media card (SMC), an SD card, or a flash card that is equipped on the server 1.

Further, the memory 11 may also include an internal storage unit of the server 1 and an external storage device. The memory 11 can be used not only to store application software and various data installed in the server 1, such as the code of a focus program 10 of the photographing device, but also to temporarily store data that has been output or will be output.

In some embodiments, the processor 12 may be a central processing unit (CPU), a controller, a microcontroller, microprocessor or other data processing chips, and is configured to operate a program code stored in the memory 11 or process data, for example, to execute the focus program 10 of the photographing device and the like.

The network interface 13 may optionally include a standard wired interface and a wireless interface (e.g., a WI-FI interface), and is usually configured to establish a communication connection between the server 1 and other electronic devices.

The network may be an Internet, a cloud network, a wireless fidelity (Wi-Fi) network, a personal network (PAN), a local area network (LAN), and/or a metropolitan area network (MAN). Various devices in a network environment can be configured to be connected to the communication network according to various wired and wireless communication protocols. Examples of such wired and wireless communication protocols may include, but are not limited to, at least one of the following: transmission control protocol and Internet protocol (TCP/IP), user datagram protocol (UDP), hypertext transfer protocol (HTTP), file transfer protocol (FTP), ZigBee, EDGE, IEEE 802.11, light fidelity (Li-Fi), 802.16, IEEE 802.11s, IEEE 802.11g, multi-hop communication, wireless access point (AP), device-to-device communication, cellular communication protocol and/or Blue tooth communication protocol or a combination thereof.

Optionally, the server may further include a user interface. The user interface may include a display and an input unit such as a keyboard. The optional user interface may also include a standard wired interface and a wireless interface. Optionally, in some embodiments, the display may be a light-emitting diode (LED) display, a liquid crystal display, a touch-sensitive liquid crystal display, an organic light-emitting diode (OLED) touch device, etc. The display may also be referred to as a display screen or a display unit, which is configured to display information processed in the server 1 and to display a visualized user interface.

FIG. 1 only shows the server 1 with the components 11 to 13 and the focus program 10 of the photographing device. Those skilled in the art can understand that the structure shown in FIG. 1 does not constitute a limitation on the server 1, and may include fewer or more components than those shown, or combination of certain components, or different component arrangements.

In this embodiment, the processor 12 can be configured to invoke the focus program for a photographing device stored in the memory 11 and execute the following operations:

acquiring a preset number of driving steps and a first rotation direction of a motor shaft in a first preset driving command;

acquiring a historical rotation direction of the motor shaft;

determining whether the first rotation direction is consistent with the historical rotation direction;

if the first rotation direction is consistent with the historical rotation direction, determining a first number of driving steps to be the preset number of driving steps;

if the first rotation direction is not consistent with the historical rotation direction, performing the following steps:

determining the first number of driving steps based on a sum of the preset number of driving steps and a preset number of correction steps first, wherein the preset number of correction steps is greater than or equal to the number of idling steps of the motor; and

controlling the motor to rotate for the first number of driving steps in the first rotation direction, and controlling the motor to rotate for the preset number of correction steps in the second rotation direction to a first target position, wherein the second rotation direction is opposite to the first rotation direction.

In one embodiment, the processor 12 can be configured to invoke the focus program for a photographing device stored in the memory 11 and execute the following operations:

the focusing method for a photographing device further includes:

generating the first preset driving command according to an autofocus algorithm and a current focus state of the photographing device.

In one embodiment, the processor 12 can be configured to invoke the focus program for a photographing device stored in the memory 11 and execute the following operations:

after the motor moves to the first target position, the focusing method for a photographing device further includes:

if the first rotation direction is not consistent with the historical rotation direction, updating the historical rotation direction into the second rotation direction.

In one embodiment, the processor 12 can be configured to invoke the focus program for a photographing device stored in the memory 11 and execute the following operations:

the motor is one or two of a zoom motor and a focus motor.

In one embodiment, the processor 12 can be configured to invoke the focus program for a photographing device stored in the memory 11 and execute the following operations:

when the motor is a zoom motor, after the zoom motor moves to the first target position, the focusing method of a photographing device further includes:

acquiring a current focal length of the photographing device;

generating a second preset driving command of the focus motor of the photographing device based on a focal length-focus table; and

controlling the focus motor based on the second preset driving command to complete focusing of the photographing device.

In one embodiment, the processor 12 can be configured to invoke the focus program for a photographing device stored in the memory 11 and execute the following operations:

the generating a second preset driving command of the focus motor of the photographing device based on a focal length-focus table includes:

acquiring a theoretical number of driving steps corresponding to the current focal length based on the focal length-focus comparison table;

acquiring a preset adjustment interval based on the theoretical number of driving steps; and

generating the second preset driving command based on the preset adjustment interval.

In one embodiment, the processor 12 can be configured to invoke the focus program for a photographing device stored in the memory 11 and execute the following operations:

the acquiring a preset adjustment interval of the focus motor based on the theoretical number of driving steps includes:

respectively calculating a sum and a difference between the theoretical number of driving steps and a preset adjustment value to respectively serve as two end points of the present adjustment interval.

In one embodiment, the processor 12 can be configured to invoke the focus program for a photographing device stored in the memory 11 and execute the following operations:

the controlling the focus motor based on the second preset driving command to complete focusing of the photographing device comprises:

controlling the focus motor to move from any end point of the preset adjustment interval to the other end point; and

controlling the focus motor to move to a second target position after the focus motor moves to the other end point, wherein the second target position corresponds to a clearest image acquisition position in the preset adjustment interval.

Based on the hardware architecture of the above photographing device, an embodiment of a focusing method for a photographing device of the present invention is provided. The focusing method for a photographing device is directed to solve the technical problem of low focusing speed of the current photographing device.

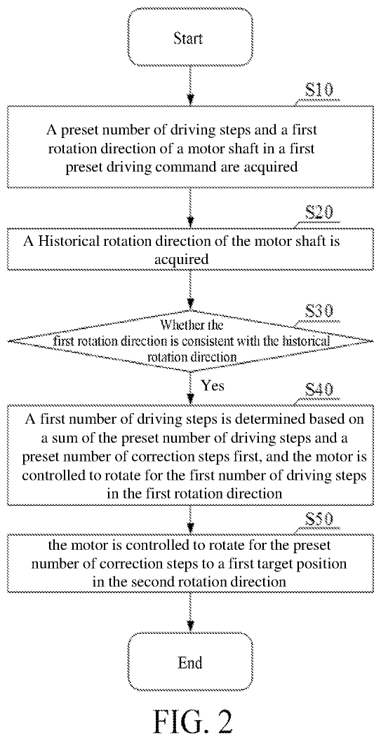

Referring to FIG. 2, FIG. 2 is one embodiment of a focusing method for a photographing device of the present invention. The focusing method for a photographing device includes the following steps.

S10, a preset number of driving steps and a first rotation direction of a motor shaft in a first preset driving command are acquired.

The first preset driving command refers to an instruction determined by the processor according to a predetermined focus algorithm and a current focus state of the photographing device. The driving command includes a number of steps of rotation of the motor and a rotation direction of the motor (i.e., the rotation direction of the motor shaft), and is configured to control the motor shaft of the motor to rotate for a preset number of steps in a certain direction (clockwise or counterclockwise). The number of steps of rotation of the motor and the rotation direction of the motor shaft included in the driving command are the preset number of driving steps and the first rotation direction.

It is worth mentioning that in general, before the delivery of the photographing device, the manufacturer will train the autofocus algorithm of the photographing device, so that the photographing device can quickly realize focusing after delivery. In the training process before leaving the factory, there is still a problem of idling of the motor. Due to the problem of idling of the motor, an actual position of the lens is inconsistent with a logical position. However, since the number of idling steps of the motor is difficult to measure, a parameter recorded in the autofocus algorithm is the logical position of the lens, while a parameter actually used is the actual position of the lens. Since the number of idling steps of the motor is fixed, there is a fixed corresponding relationship, even though the actual position of the lens is inconsistent with the logical position in the training process. For example, if the number of idling steps of the motor is 10, the actual position of the lens corresponding to the logical position 300 of the lens is 290, and the actual position of the lens corresponding to the logical position 200 of the lens is 190.

In one exemplary focusing method for a photographing device, a processor directly sends a driving command to the motor according to the logical position of the lens during focusing of the photographing device. The existence of idling of the motor will cause that the logical position-actual position of the lens in the focusing process cannot satisfy the logical position-actual position corresponding relationship in the autofocus algorithm, resulting in that the photographing device cannot focus quickly according to the trained autofocus algorithm, and effecting the focusing speed of the photographing device.

In the present application, the processor may acquire a preset number of driving steps and a first rotation direction in the first preset driving command before sending the first preset driving command to the motor. That is, in the present application, during focusing, the processor does not directly control the motor to work through the first preset driving command

S20, a historical rotation direction of the motor shaft is acquired.

Specifically, the historical rotation direction is a rotation direction of the motor shaft when the motor moves for the last time before receiving a new driving command

It is worth mentioning that the photographing device will perform autofocus (AF) self check after being initiated. In AF self check, the lens of the photographing device will be moved. Therefore, the historical rotation direction of the motor shaft should be the rotation direction of the photographing device in the AF self check when the photographing device completes the AF self check and executes a focus task at the first time.

Moreover, it should also be noted that there is a motor idling phenomenon in the AF self check process of the photographing device. The photographing device may control the lens to move unilaterally away from the video camera during AF self check. That is, in the AF self check process, the motor rotates in one direction. Therefore, after AF self check, the actual position of the lens is a distance of one idling step backward relative to the logical position (the side with a video camera main body is the back).

S30, whether the first rotation direction is consistent with the historical rotation direction is determined.

In order to facilitate determining whether the first rotation direction and the historical rotation direction are consistent, the rotation direction of the motor shaft can be stored in the form of a numerical value. For example, when the motor shaft rotates clockwise, the rotation direction of the motor shaft can be recorded as “0,” and when the motor shaft rotates counterclockwise, the rotation direction of the motor shaft can be recorded as “1.” As such, it can be determined whether the first rotation direction is consistent with the historical rotation direction by comparing the numerical value of the first rotation direction with the numerical value of the historical rotation direction.

Specifically, a step S40 is executed when the first rotation direction in the first preset driving command is inconsistent with the historical rotation direction of the motor shaft.

S40, a first number of driving steps is determined based on a sum of the preset number of driving steps and a preset number of correction steps first, and the motor is controlled to rotate for the first number of driving steps in the first rotation direction, wherein the preset number of correction steps is greater than or equal to the number of idling steps of the motor.

The preset number of correction steps is configured to correct a lens displacement error caused by the motor idling, and can be obtained by repeated tests before the delivery of the photographing device. The purpose of setting the preset number of correction steps to be greater than or equal to the number of idling steps of the motor is to avoid the problem that the motor rotates but the lens does not move within the preset number of correction steps when the preset number of correction steps is less than the number of idling steps of the motor.

Specifically, when the processor determines that the first rotation direction in the first preset driving command is inconsistent with the historical rotation direction of the motor shaft, the preset number of correction steps stored in a memory will be invoked, and the first number of driving steps is determined based on the sum of the preset number of correction steps and the preset number of driving steps in the first preset driving command. The processor controls the motor to rotate for the first number of driving steps in the first rotation direction after obtaining the first number of driving steps. In this process, the first rotation direction is inconsistent with the historical rotation direction, so that there may be the motor idling phenomenon. As a result, the actual number of steps of the motor differs by one idling step compared with the logical number of steps. At this time, after the AF self check, the actual number of steps of the motor also differs by one idling step compared with the logical number of steps, so that after the step S40 is terminated, the logical position of the lens is kept consistent with the actual position.

It is worth mentioning that in comparison with the preset number of driving steps, the motor is driven based on the first number of driving steps, which will cause the lens of the photographing device to be positioned farther back or forward than the position corresponding to the first preset driving command

S50, the motor is controlled to rotate for the preset number of correction steps to a first target position in the second rotation direction, wherein the second rotation direction is opposite to the first rotation direction.

Specifically, the second rotation direction is opposite to the first rotation direction, so that the motor may also have the idling phenomenon in the process of rotating the preset number of correction steps in the second rotation direction. After the step S40, the actual position of the lens is consistent with the logical position. After the step S50 is terminated, the actual position of the lens is a distance of one idling step backward relative to the logical position. In the process of factory training of the photographing device, the actual position of the lens and the logical position are also at a distance of one idling step (the factory training of the photographing device is generally to control the lens to move from the minimum focal length to the maximum focal length, so that the actual position of the lens and the logical position are at the distance of one idling step).

That is, after the step S50 is terminated, the logical position of the lens is consistent with the logical position corresponding to the first preset driving command, and the actual position of the lens is kept consistent with this logical position. That is, the logical position-actual position of the lens satisfies the logical position-actual position corresponding relationship in the autofocus algorithm. As such, autofocus of the photographing device can be realized according to a preset focus algorithm, thereby improving the focusing speed of the photographing device.

Exemplarily, a focus motor with 10 idling steps is taken as an example to describe the solution of the present application (for the convenience of calculation, the number of steps of the motor represents the displacement of the lens).

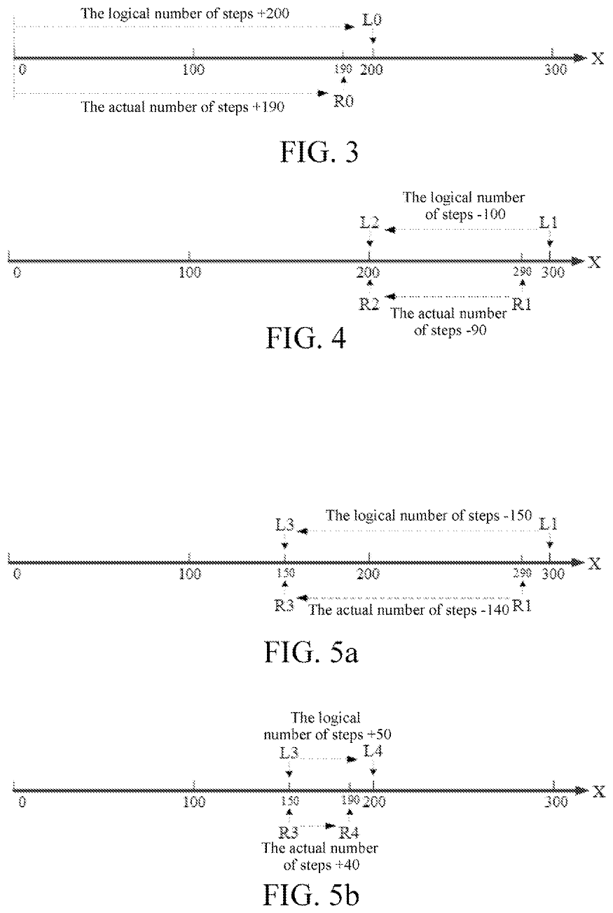

Referring to FIG. 3, FIG. 3 shows a schematic diagram of a position state of a lens of a photographing device in a factory training process.

In the factory training process, an initial position of the lens is 0. If the lens is controlled to move 200 steps toward an X direction, after the focus motor stops, the logical position L0 of the lens is 200, and the actual position R0 of the lens is 190 due to the existence of motor idling.

Referring to FIG. 4, FIG. 4 shows a schematic diagram of a position state of a lens when an exemplary focusing method is used to perform focusing.

When the exemplary focusing method is used to perform focusing, if an initial logical position L1 of the lens is 300 after the AF self check of the photographing device, an initial actual position R1 of the lens is 290 due to the existence of motor idling.

If, during focusing, the first preset driving command sent by the processor is to control the lens to move from 300 to 200, then, after the motor executes the previously described first preset driving command, the logical position L2 of the lens is 300−100=200.

At this time, if the motor shaft selects clockwise when the lens moves from 0 to 300, the motor shaft rotates counterclockwise when the lens moves from 300 to 200. That is, when the lens moves from 300 to 200, the rotation direction of the motor shaft changes, so the motor idling phenomenon is generated. Based on this, the actual position R2 of the lens is 290−(100−10)=200. At this time, the actual position of the lens is consistent with the logical position.

However, it can be seen from FIG. 3 that the actual position corresponding to the logical position 200 of the lens should be 190. At this time, the actual position of the lens is inconsistent with data actually used in the autofocus algorithm, which will cause that the photographing device cannot realize quick focusing according to the autofocus algorithm.

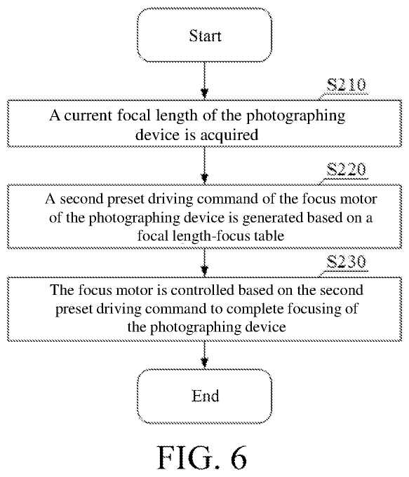

Referring to FIG. 5a and FIG. 5b, FIG. 5a and FIG. 5b show schematic diagrams of position states of a lens when a focusing method for a photographing device of the present application is used.

If an initial logical position L1 of the lens is 300 after the AF self check of the photographing device, an initial actual position R1 of the lens is 290 due to the existence of motor idling.

If, during focusing, the first preset driving command sent by the processor is to control the lens to move from 300 to 200, then at this time, the preset number of driving steps is −100 (the sign “−” only represents a motion of the lens toward “0”), the first rotation direction is counterclockwise (it is assumed that the rotation direction of the motor shaft is clockwise when the lens moves toward an x direction). If the preset number of correction steps is 50, the first number of driving steps is −(100+50)=−150.

Based on this,

at a first stage of control (i.e., the step S40):

the logical position L3 of the lens is 300−150=150;

the actual position R3 of the lens is 290−(150−10)=150;

at a second stage of control (i.e., the step S50):

the logical position L3 of the lens is 150+50=200; and

the actual position R3 of the lens is 150+(50−10)=190.

Since the actual position of the lens corresponding to the logical position 200 of the lens is 190, the actual position data of the lens is consistent with the position data of the lens used in the autofocus algorithm, and then the photographing device can realize quick focusing according to the autofocus algorithm.

It is worth mentioning that the preset number of correction steps can be adaptively adjusted according to different actual situations of each photographing device, and the present application does not specifically limit this. Since the number of idling steps of the motor is usually very small, it can be ensured that the preset number of correction steps is greater than or equal to the number of idling steps of the motor by just integrating the size and number of teeth of a transmission gear to obtain an empirical value and setting the preset number of correction step to be greater than the empirical value.

In conclusion, in the focusing method for a photographing device in the technical solutions of the present application, when it is determined that the first rotation direction in the first preset driving command is inconsistent with the historical rotation direction of the motor shaft, the motor is controlled to rotate for the first number of driving steps in the first rotation direction first and is then controlled to rotate for the number of correction steps in the second rotation direction, so that actual position data of a lens is matched with position data used in the autofocus algorithm, thereby greatly increasing the focusing speed of the photographing device.

It is also worth mentioning that an error between each motor and a gear transmission mechanism of the lens is inconsistent, which leads to that the number of idling steps of each motor is inconsistent. Moreover, since the number of idling steps of the motor is usually very small, if the number of idling steps of the motor is tested for each photographing device one by one to solve the problem of motor idling, there is no doubt that a huge amount of engineering is needed, which greatly increases the labor cost and material cost required for debugging. In the technical solution of the present application, the problem of motor idling can be avoided without testing the number of idling steps of the motor of each photographing device, so that the advantage of low cost is achieved.

In one embodiment, before a first preset driving command is sent to a motor, the focusing method for a photographing device further includes:

the first preset driving command is acquired according to an autofocus algorithm and a current focus state of the photographing device.

The autofocus algorithm of the photographing device is a preferred focus solution obtained by the manufacturer through repeated targeted training according to applications of the photographing device before the delivery of the photographing device. The current focus state refers to an imaging condition of the photographing device under the current focal length and according to the imaging condition and the autofocus algorithm, the lens is driven to move to obtain driving command for a clear image.

Specifically, after the photographing device completes self check, or a photographing object of the photographing device changes, the photographing device starts to re-focus. At this time, a corresponding driving command that drives the photographing device for focusing can be generated, and the driving command is the first preset driving command.

In one embodiment, after the motor moves to the first target position, the focusing method for a photographing device further includes:

the historical rotation direction is updated into the second rotation direction.

It can be understood that the second rotation direction is a direction of last rotation of the motor shaft before the next motion starts (or before the motor receives a next driving command of the processor). The historical rotation direction is updated to the second rotation direction. As such, the processor can directly acquire the historical rotation direction of the motor shaft when sending a first preset driving command to the motor shaft at the next time, thereby facilitating improving the data processing efficiency of the photographing device. Meanwhile, updating the historical rotation direction to the second rotation direction means that the memory only stores one latest historical rotation direction. As such, on the one hand, the data storage volume can be reduced, and on the other hand, the problem that the processor mis-reads non-latest historical rotation direction data and sends a wrong driving command to the motor can be avoided. Of course, the design of the present application is not limited to this. In other embodiments, the memory can also store the rotation direction of the motor shaft each time the motor works. At this time, the processor can screen out a desired historical rotation direction based on a preset rule from the data stored in the memory.

In one embodiment, the motor is one or two of a zoom motor and a focus motor.

Specifically, the focusing method for a photographing device of the present application can be independently applied to the zoom motor or the focus motor of the photographing device, or can be simultaneously applied to the zoom motor and the focus motor of the photographing device.

As shown in FIG. 6, in one embodiment, when the motor is a zoom motor, after the zoom motor moves to the first target position, the focusing method of a photographing device further includes:

S210, a current focal length of the photographing device is acquired.

Specifically, the focal length of the photographing device changes after the zoom motor moves to the first target position based on the focusing method provided by the previously described embodiment. At this time, a current focal length after lens zoom needs to be determined at first in order to realize quick focusing. After the current focal length of the lens is determined, the focus of the lens can be adaptively adjusted according to the current focal length to realize quick focusing.

S220, a second preset driving command of the focus motor of the photographing device is generated based on a focal length-focus table.

The focal length-focus table is obtained by training before the delivery of the photographing device. The movement of the zoom motor of the photographing device will change the focal length of the lens, and the movement of the focus motor will change the focus of the lens. During focusing of the photographing device, the focal length and the focus of the lens can be adaptively adjusted. That is, during focusing, the zoom motor and the focus motor may work cooperatively. Based on this, the focal length-focus table is actually a zoom-focus position corresponding table. In a general case, during focusing training, the focal length may be adjusted at first through the zoom motor; and after the adjustment for the focal length is completed, the focus of the lens is then adjusted through the focus motor to realize focusing. That is, the zoom-focus position corresponding table shows preferred focus positions at different zoom positions (generally, the preferred focus positions are the optimal focus positions), i.e., preferred focus values at different focal lengths. It is worth mentioning that after the training is completed, the focal length-focus table is stored in the memory of the photographing device so that the photographing device quickly finishes the focusing operation during execution of the focusing task after the delivery.

Specifically, after the current focal length of the photographing device is determined, the second preset driving command of the focus motor can be determined based on the current focal length and the focal length-focus table obtained by training.

S230, the focus motor is controlled based on the second preset driving command to complete focusing of the photographing device.

Focusing completion means that the photographing device obtains the clearest image at the current focal length.

Specifically, after the second preset driving command is determined, the processor can control the focus motor based on the second preset driving command to adjust the focus of the lens at the current focal length till the focusing is completed. The second preset driving command is obtained based on the trained focus-focal length table, so that controlling the focus motor based on the second preset driving command to perform focusing can greatly improve the focusing speed of the photographing device.

It can be understood that compared with the exemplary focusing method, the focusing method for a photographing device according to the technical solution of the present application greatly improves the focusing speed of the photographing device by means of separately controlling the zoom motor and the focus motor.

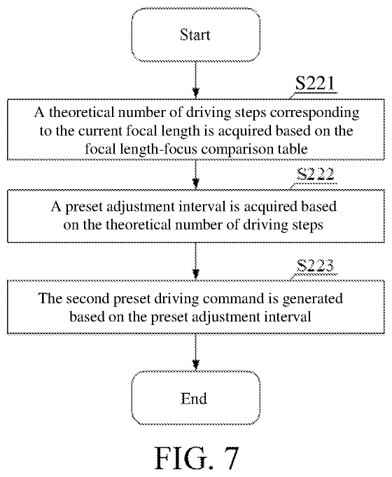

As shown in FIG. 7, in one embodiment, the step that a second preset driving command of the focus motor of the photographing device is generated based on a focal length-focus table includes:

S221, a theoretical number of driving steps corresponding to the current focal length is acquired based on the focal length-focus comparison table.

Specifically, the focal length and the focus of the photographing device are associated with the position of the lens, and the position of the lens is associated with the numbers of driving steps of the focus motor and the zoom motor. Therefore, after the focus corresponding to the current focal length of the photographing device is acquired from the focal length-focus comparison table, the number of driving steps of the focus motor corresponding to this focus can be further obtained. The number of driving steps is the theoretical number of driving steps desired at the step S221.

S222, a preset adjustment interval is acquired based on the theoretical number of driving steps.

Specifically, different from a zoom task, the photographing device needs to constantly adjust the focus during execution of the focus task, and collects images in real time till a clear image is obtained. When this action corresponds to an action of the focus motor. That is, during focusing, the focus motor may move within one adjustment interval till the photographing device collects a clear image, and completes the focusing. The number of driving steps is an actual number of focusing steps of the focus motor when the photographing device completes the focusing.

In one exemplary technical solution, in order to realize focusing, the processor may drive the focus motor to move within a relatively large interval, which causes that the photographing takes relatively long time to actually complete the focusing. In this present application, the theoretical number of driving steps is a preferable number of driving steps of the focus motor obtained based on the current focal length of the photographing device, so that the preset adjustment interval of the focus motor is determined by means of the theoretical number of driving steps. Compared with a conventional adjustment interval of the focus motor, the scope of the preset adjustment interval is closer to the actual number of focus steps of the photographing device, which is thus favorable for completing the focusing of the photographing device faster.

S223, the second preset driving command is generated based on the preset adjustment interval.

Specifically, after the preset adjustment interval is determined, the corresponding second preset driving command can be generated based on the preset adjustment interval. It can be understood that compared with the exemplary technical solution, the technical solution based on the preset adjustment interval has the advantage that the focusing of the photographing device can be realized faster by means of the second preset driving command of the present application.

In one embodiment, the step that a preset adjustment interval of the focus motor is acquired based on the theoretical number of driving steps includes:

a sum and a difference between the theoretical number of driving steps and a preset adjustment value are respectively calculated to respectively serve as two end points of the present adjustment interval.

The preset adjustment value is a preferred value obtained based on experiments before the delivery of the photographing device. The preset adjustment interval calculated based on the theoretical number of driving steps and this adjustment value can cover the actual number of focus steps of the photographing device within an interval scope as small as possible, thus realizing quick focusing of the photographing device. It is worth mentioning that the preset adjustment value can be adaptively adjusted according to an actual situation of the photographing device, and the present application does not specifically limit this.

Correspondingly, the step that the focus motor is controlled based on the second preset driving command to complete focusing of the photographing device includes:

the focus motor is controlled to move from any end point of the preset adjustment interval to the other end point; and

controlling the focus motor to move to a second target position after the focus motor moves to the other end point, wherein the second target position corresponds to a clearest image acquisition position in the preset adjustment interval.

Specifically, the photographing device can constantly collect images in the process that the focus motor moves from any end point of the preset adjustment interval to the other end point. After the motion is completed, the processor may compare each image to determine the clearest image. After the clearest image is determined, the processor may control the focus motor to move to the position corresponding to the clearest image. At this time, the photographing device completes the focusing.

In addition, the embodiments of the present invention further provide a computer-readable storage medium. The computer-readable storage medium may be any one of or a combination of several of a hard disk, a multimedia card, an SD card, a flash card, an SMC, a read-only memory (ROM), an erasable programmable read-only memory (EPROM), a compact disk read-only memory (CD-ROM), and a USB memory. The computer-readable storage medium includes a focus program 10 of the photographing device. A specific implementation of the computer-readable storage medium of the present invention is substantially the same as the specific implementations of the previously described focusing method for a photographing device and the server 1, so that the details are omitted here.

A person skilled in the art should understand that the embodiments of this application may be provided as a method, a system, or a computer program product. Therefore, this application may be in a form of complete hardware embodiments, complete software embodiments, or combination of software and hardware. Moreover, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to the embodiments of this application. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the block diagrams is generated by using instructions executed by the computer or the processor of another programmable data processing device.

These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions may further be loaded onto a computer or another programmable data processing device, so that a series of operations and steps are performed on the computer or another programmable device, thereby generating computer-implemented processing. Therefore, the instructions executed on the computer or another programmable device provide steps for implementing a specific function in one or more processes in the flowcharts and/or in one or more blocks in the block diagrams.

Although some exemplary embodiments of the present invention have been described, persons skilled in the art can make changes and modifications to these embodiments once they learn the basic inventive concept. Therefore, the following claims are intended to be construed as to cover the exemplary embodiments and all changes and modifications falling within the scope of the present disclosure

Obviously, a person skilled in the art can make various modifications and variations to the present invention without departing from the scope of the present invention.

The present invention is intended to cover these modifications and variations provided that they fall within the scope of protection defined by the following claims and their equivalent technologies.

What is claimed is:

1. A focusing method for a photographing device, comprising:
generating a preset number of driving steps and a first rotation direction of a motor shaft in a first preset driving instruction;
acquiring a historical rotation direction of the motor shaft;
determining whether the first rotation direction is consistent with the historical rotation direction;
if the first rotation direction is not consistent with the historical rotation direction, performing the following steps:
determining a first number of driving steps based on a sum of the preset number of driving steps and a preset number of correction steps first, wherein the preset number of correction steps is greater than or equal to the number of idling steps of the motor; and
controlling the motor to rotate the first number of driving steps according to the first rotation direction, and controlling the motor to rotate the preset number of correction steps to a first target position based on the second rotation direction, wherein the second rotation direction is opposite to the first rotation direction.

2. The focusing method for a photographing device according to claim 1, wherein the focusing method for a photographing device further comprises:
generating the first preset driving command according to an auto focus algorithm and a current focus state of the photographing device.

3. The focusing method for a photographing device according to claim 1, wherein after the motor moves to the first target position, the focusing method for a photographing device further comprises:
updating the historical rotation direction into the second rotation direction if the first rotation direction is not consistent with the historical rotation direction.

4. The focusing method for a photographing device according to claim 3, wherein when the motor is a zoom motor, after the zoom motor moves to the first target position, the focusing method of a photographing device further comprises:
acquiring a current focal length of the photographing device;
generating a second preset driving command of the focus motor of the photographing device based on a focal length-focus table; and
controlling the focus motor based on the second preset driving command to complete focusing of the photographing device.

5. The focusing method for a photographing device according to claim 4, wherein the generating a second preset driving command of the focus motor of the photographing device based on a focal length-focus table comprises:
acquiring a theoretical number of driving steps corresponding to the current focal length based on the focal length-focus comparison table;
acquiring a preset adjustment interval based on the theoretical number of driving steps; and
generating the second preset driving instruction based on the preset adjustment interval.

6. The focusing method for a photographing device according to claim 5, wherein the acquiring a preset adjustment interval of the focus motor based on the theoretical number of driving steps comprises:
respectively calculating a sum and a difference between the theoretical number of driving steps and a preset adjustment value to respectively serve as two end points of the present adjustment interval.

7. The focusing method for a photographing device according to claim 7, wherein the controlling the focus motor based on the second preset driving instruction to complete focusing of the photographing device comprises:
controlling the focus motor to move from any end point of the preset adjustment interval to the other end point; and
controlling the focus motor to move to a second target position after the focus motor moves to the other end point, wherein the second target position corresponds to a clearest image acquisition position in the preset adjustment interval.

8. A photographing device, comprising a memory and a processor, wherein the memory stores a focusing program for implementing a focusing method for the photographing device and the processor is configured to execute the focusing program to implement the focusing method; wherein the focusing method comprising:
generating a preset number of driving steps and a first rotation direction of a motor shaft in a first preset driving instruction;
acquiring a historical rotation direction of the motor shaft;
determining whether the first rotation direction is consistent with the historical rotation direction;
if the first rotation direction is not consistent with the historical rotation direction, performing the following steps:
determining a first number of driving steps based on a sum of the preset number of driving steps and a preset number of correction steps first, wherein the preset number of correction steps is greater than or equal to the number of idling steps of the motor; and
controlling the motor to rotate the first number of driving steps according to the first rotation direction, and controlling the motor to rotate the preset number of correction steps to a first target position based on the second rotation direction, wherein the second rotation direction is opposite to the first rotation direction.

9. The photographing device according to claim 8, wherein the focusing method further comprises:
generating the first preset driving command according to an auto focus algorithm and a current focus state of the photographing device.

10. The photographing device according to claim 8, wherein after the motor moves to the first target position, the focusing method further comprises:
updating the historical rotation direction into the second rotation direction if the first rotation direction is not consistent with the historical rotation direction.

11. The photographing device according to claim 10, wherein when the motor is a zoom motor, after the zoom motor moves to the first target position, the focusing method of a photographing device further comprises:
acquiring a current focal length of the photographing device;
generating a second preset driving command of the focus motor of the photographing device based on a focal length-focus table; and
controlling the focus motor based on the second preset driving command to complete focusing of the photographing device.

12. The photographing device according to claim 11, wherein the generating a second preset driving command of the focus motor of the photographing device based on a focal length-focus table comprises:
acquiring a theoretical number of driving steps corresponding to the current focal length based on the focal length-focus comparison table;
acquiring a preset adjustment interval based on the theoretical number of driving steps; and
generating the second preset driving instruction based on the preset adjustment interval.

13. The photographing device according to claim 12, wherein the acquiring a preset adjustment interval of the focus motor based on the theoretical number of driving steps comprises:
respectively calculating a sum and a difference between the theoretical number of driving steps and a preset adjustment value to respectively serve as two end points of the present adjustment interval.

14. The photographing device according to claim 12, wherein the controlling the focus motor based on the second preset driving instruction to complete focusing of the photographing device comprises:
controlling the focus motor to move from any end point of the preset adjustment interval to the other end point; and
controlling the focus motor to move to a second target position after the focus motor moves to the other end point, wherein the second target position corresponds to a clearest image acquisition position in the preset adjustment interval.

15. A computer-readable storage medium, storing a focusing program for implementing a focusing method for a photographing device; and wherein the photographing device comprises a processor configured to execute the focusing program to implement the focusing method; wherein the focusing method comprises:
generating a preset number of driving steps and a first rotation direction of a motor shaft in a first preset driving instruction;
acquiring a historical rotation direction of the motor shaft;
determining whether the first rotation direction is consistent with the historical rotation direction;
if the first rotation direction is not consistent with the historical rotation direction, performing the following steps:
determining a first number of driving steps based on a sum of the preset number of driving steps and a preset number of correction steps first, wherein the preset number of correction steps is greater than or equal to the number of idling steps of the motor; and
controlling the motor to rotate the first number of driving steps according to the first rotation direction, and controlling the motor to rotate the preset number of correction steps to a first target position based on the second rotation direction, wherein the second rotation direction is opposite to the first rotation direction.

16. The computer-readable storage medium according to claim 15, wherein the focusing method further comprises:
generating the first preset driving command according to an auto focus algorithm and a current focus state of the photographing device.

17. The computer-readable storage medium according to claim 15, wherein after the motor moves to the first target position, the focusing method further comprises:
updating the historical rotation direction into the second rotation direction if the first rotation direction is not consistent with the historical rotation direction.

18. The computer-readable storage medium according to claim 17, wherein when the motor is a zoom motor, after the zoom motor moves to the first target position, the focusing method of a photographing device further comprises:
acquiring a current focal length of the photographing device;
generating a second preset driving command of the focus motor of the photographing device based on a focal length-focus table; and
controlling the focus motor based on the second preset driving command to complete focusing of the photographing device.

19. The computer-readable storage medium according to claim 18, wherein the generating a second preset driving command of the focus motor of the photographing device based on a focal length-focus table comprises:
acquiring a theoretical number of driving steps corresponding to the current focal length based on the focal length-focus comparison table;
acquiring a preset adjustment interval based on the theoretical number of driving steps; and
generating the second preset driving instruction based on the preset adjustment interval.

20. The computer-readable storage medium according to claim 19, wherein the acquiring a preset adjustment interval of the focus motor based on the theoretical number of driving steps comprises:
respectively calculating a sum and a difference between the theoretical number of driving steps and a preset adjustment value to respectively serve as two end points of the present adjustment interval.

21. The computer-readable storage medium according to claim 19, wherein the controlling the focus motor based on the second preset driving instruction to complete focusing of the photographing device comprises:
controlling the focus motor to move from any end point of the preset adjustment interval to the other end point; and
controlling the focus motor to move to a second target position after the focus motor moves to the other end point, wherein the second target position corresponds to a clearest image acquisition position in the preset adjustment interval.
